(19) United States
(12) Patent Application Publication
(10) Pub. No.: US 2013/0130261 A1
(43) Pub. Date: May 23, 2013

(54) CHEMICAL SENSOR

(71) Applicants: Themistoklis Prodromakis, London (GB); Christofer Toumazou, London (GB)

(72) Inventors: Themistoklis Prodromakis, London (GB); Christofer Toumazou, London (GB)

(73) Assignee: VAGONYX LIMITED, Road Town, Tortula (VG)

(21) Appl. No.: 13/813,770

(22) PCT Filed: Sep. 6, 2011
(86) PCT No.: PCT/IB2011/053900

§ 371 Date: Feb. 1, 2013

(30) Foreign Application Priority Data
Aug. 3, 2010 (GB) 1012993.0

(51) Int. Cl. G01N 27/60

(52) U.S. Cl. CPC G01N 27/60
USPC 435/6.11; 422/82.01; 436/149; 435/287.2; 427/58

(57) ABSTRACT

A sensor comprising a memory device having a first electrode and a first chemical-sensing layer coupled to the first electrode. The chemical-sensing layer, in the presence of an analyte, is arranged to change a property of the Memristive device. The sensor can detect an analyte by providing a sample to be detected proximate the chemical sensing layer, observing the state of the memory element; and determining a property of the sample by comparing the observed state of the memory element with a previous state. The sensor is manufactured by depositing a second electrode on a surface, depositing an active layer or layers onto said second electrode, depositing a first electrode onto said active layer(s), and coupling a chemically sensitive layer to the first electrode.

### FIELD OF THE INVENTION

The present invention relates to a sensing apparatus and method. The invention may be used in detecting neural activity or chemical events.

### BACKGROUND

Over the past 40 years, chemical sensors and electrode arrays have been used to affiliate the chemical and electrical domains, enabling the development of biologically inspired systems for a number of applications. In theory, the physical dimensions and selectivity of the transducers determine the minimal biological activities that can be sensed or triggered. However, conventional chemical sensors typically suffer from a relatively low chemical sensing resolution while their scaling works against the reliability of the sensors.

Chemical sensor advancement has linked the chemical and electrical domains, enabling the development of biologically inspired systems for a number of applications. Nevertheless, even simple biological functions may require a large number of transconducting elements for effectively imitating the function of their counterparts. A similar trend with Moore's scaling law is therefore established in the development of chemical sensors.

Biological functions are mainly expressed via the diffusion of ions, with the chemical synapse being an excellent example of such an electro-chemical interaction. The chemical synapse is essentially the smallest communication channel existing in nature, linking a neuron with one or more other neurons via the propagation of action potentials. The strength g_{syn}(t) of a synapse depends on its history and more explicitly by the overall amount of neurotransmitters that has been propagated through it, which is mathematically expressed by:

$$\begin{matrix}{I}_{syn} = {g}_{syn} ( t ) ( {V}_{m} - {E}_{r} ) & ( 1 ) \\ \frac{d {V}_{m}}{d t} = - \frac{1}{{C}_{m}} ( {\sum }_{i}^{ } {I}_{ion} ) & ( 2 )\end{matrix}$$

where I_{syn} is the postsynaptic current, g_{syn}(t) is the time-dependent synaptic conductance, Vₘ is the voltage across the synapse, Eᵣ is the reversal potential of the channel, Cₘ is the membrane's capacitance and Iᵢₒₙ is the ionic current.

Hodgkin and Huxley have particularly described the biophysical characteristics of cell membranes via the conduction of ionic currents due to sodium (Na⁺) and potassium (K⁺) ions. A set of time-varying conductances describe the various ionic currents (I_{Na} and I_{K}) propagating through the membrane due to the neurotransmitter release, shown in FIGS. 6 (b) and (c).

Thanapitak and Toumazou have recently proposed the realization of a chemical bionic synapse in CMOS (Complementary Metal-Oxide Semiconductor) that models the non-linear electrochemical behaviour of the synapse. This approach is based on current-mode circuitry while the chemical interfacing is achieved via ISFETs.

The following references provide background:
1. L. O. Chua, “Memristor—The missing circuit element”, Transactions on Circuits Theory IEEE, vol. CT-18, no. 5, pp. 507-519, September 1971.
2. L. Chua and S. Kang, “Memristive devices and systems,” Proceedings of the IEEE, vol. 64, no. 2, pp. 209-223, 1976.
3. B. Widrow, W. H. Pierce and J. B. Angell Birth, “Life, And Death In Microelectronic Systems”, Office of Naval Research Technical Report 1552-2/1851-1, May 30, 1961
4. F. Argall, “Switching Phenomena in Titanium Oxide Thin Films”, Solid-State Electronics, Pergamon Press, 535-541, 27 Jul. 1967, Vol. 11.
5. A. Beck, J. G. Bednorz, Ch. Gerber, C. Rossel and D. Widmer, “Reproducible switching effect in thin oxide films for memory applications”, Applied Physics Letters, vol. 77, no. 1, July 2000.
6. R. Williams, “How we found the missing memristor,” IEEE spectrum, vol. 45, no. 12, pp. 28-35, 2008.
7. J. J. Yang, M. D. Pickett, X. Li, D. A. A. Ohlberg, D. R. Stewart and R. S. Williams, “Memristive switching mechanism for metal/oxide/metal nanodevices”, Nature Nanotechnology, vol. 3, pp. 429-433, July 2008.
8. R. S. Williams, “Multi-terminal Electrically actuated switch”, US2008/0079029, Apr. 3, 2008.
9. R. S. Williams, “Electrically actuated switch”, US2008/0090337, Apr. 17, 2008.
10. K. Michelakis, T. Prodromakis and C. Toumazou, “Cost-effective fabrication of nanoscale electrode memristors with reproducible electrical response”, IET Micro and Nano Letters, vol. 5, no. 2, pp. 91-94, 2010.
11. T. Prodromakis, K. Michelakis and C. Toumazou, “Switching mechanisms in microscale Memristors”, IET Electronic Letters, vol. 46, no. 1, pp. 63-65, 2010.
12. T. Prodromakis, K. Michelakis and C. Toumazou, “Fabrication and Electrical Characteristics of Memristors with TiO2/TiO2+x active layers”, Proceedings of the IEEE International Symposium on Circuits and Systems, May 2010.
13. T. Prodromakis, K. Michelakis and C. Toumazou, “Electrically Actuated Switch”, GB 1000192.3, February 2010.
14. S. H. Jo, T. Chang, I. Ebong, B. B. Bhadviya, P. Mazumder and W. Lu, “Nanoscale Memristor Device as Synapse in Neuromorphic Systems”, Nano letters, American Chemical Society, vol. 10, no. 4 pp. 1297-1301, 2010.
15. N. Gergel-Hackett, B. Hamadani, B. Dunlap, J. Suchle, C. Richter, C. Hacker, and D. Gundlach, A flexible solution-processed memristor, IEEE Electron Device Lett., vol. 30, no. 7, pp. 706-708, 2009.
16. N. Gergel-Hackett, B. Hamadani, C. A. Richter, D. J. Gundlach, “Non-volatile memory device and processing method”, US2009/0184397, July 2009.
17. G. Moore, “Progress in digital integrated electronics”, Proc. IEEE Int. Electron Devices Meeting, pp. 11-13, Washington, D.C., USA, 1975.
18. M. J. Rozenberg, I. H. Inoue, and M. J. Sanchez, “Nonvolatile Memory with Multilevel Switching: A Basic Model”, Physical Review Letters, vol. 92, no. 17, April, 2004.
19. J. Borghetti, G. S. Snider, P. J. Kuekes, J. J. Yang, D. R. Stewart and R. S. Williams, “Memristive switches enable ‘stateful’ logic operations via material implication”, Nature Lett., vol. 464, 2010.
20. B. Linares-Barranco and T. Serrano-Gotarredona, “Memristance can explain Spike-Time-Dependent-Plasticity in Neural Synapses”, Nature Precedings: hdl:10101/npre.2009.3010.1, March 2009.
21. P. Bergveld, “Development of an ion-sensitive solid-state device for neurophysiological measurements,” IEEE Trans on Biom Eng., vol. 17, pp. 70-71, January 1970.
22. W. L. C. Rutten, “Selective electrical interfaces with the nervous system”, Annu. Rev. Biomed. Eng., vol. 4, pp. 407-52, 2002.
23. B. Sohn, B. Cho, C. Kim, and D. Kwon, “ISFET glucose and sucrose sensors by using platinum electrode and photo-crosslinkable polymers”, Sensors & Actuators: B. Chemical, vol. 41, no. 1-3, pp. 7-11, 1997.
24. P. Georgiou, I. Triantis, T. Constandinou, and C. Toumazou, “Spiking Chemical Sensor (SCS): A new platform for neuro-chemical sensing”, IEEE/EMBS Conf. on Neural Engineering, pp. 126-129, 2007.
25. T. Constandinou, P. Georgiou, T. Prodromakis, and C. Toumazou, “A CMOS-based Lab-on-Chip Array for the Combined Magnetic Stimulation and Opto-Chemical Sensing of Neural Tissue”, CNNA, 2010.
26. C. Toumazou, S. Purushothaman, “Sensing apparatus and method”, U.S. Pat. No. 7,686,929, March 2010.
27. J. Bausells, J. Carrabina, A. Errachid, and A. Merlos, “Ion-sensitive field-effect transistors fabricated in a commercial CMOS technology”, Sensors and Actuators B: Chemical, vol. 57, no. 1-3, pp. 56-62, 1999.
28. Hodgkin, A., and Huxley, A. (1952): A quantitative description of membrane current and its application to conduction and excitation in nerve. J. Physiol. 117:500-544.
29. Drakakis, E., Payne, A., Toumazou, C., Log-Domain Filtering and the Bernoulli Cell, IEEE Trans. Circuits & Systems—Part I, 1998, Vol: 46, Pages: 559-571.
30. S. Thanapitak and C. Toumazou, “Towards a Bionic Chemical Synapse”, ISCAS, pp. 677-680, May 2009.
31. P. Buhlmann, H. Aoki, K. P. Xiao, S. Amemiya, K. Tohda and Y. Umezawa, “Chemical Sensing with Chemically Modified Electrodes that Mimic Gating at Biomembranes Incorporating Ion-Channel Receptors”, Electroanalysis, vol. 10, no. 17, pp. 1149-1158, 1998

Devices have also been described in the following patent applications.

WO2010082928A1 discusses the fabrication and operation of a particular type of Memristor. The devices are actuated by applied electric field in a circuit and do not detect ionic species.

WO2010074689A1 discloses a memristive device having at least two mobile species in the active layer, each defining a separate state variable. The device does not detect ionic species, nor are the states actuated by ionic species, instead being actuated by an applied electric field.

WO02086480A1 discusses carbon nanotube devices manipulated in a manner that is used for a variety of implementations. Light is used to photodesorb molecules from a carbon nanotube and change its characteristics. However the proposed system is very complex to fabricate and maintain, requiring fragile nanotubes, vacuum chamber, and device for directing a specific light source of a specific wavelength.

The present chemical sensors tend to be quite difficult to manufacture. There is still a need to improve the sensitivity and scalability of chemical sensors. Moore's Law will eventually cease to exist as CMOS technologies are approaching the nano-scale floor, with devices attaining comparable dimensions to their constituting atoms.

It is desirable to provide a simple, mass-producible, and scalable sensor that can transducer a chemical signal into an electrical signal. The inventors have invented such a device with the benefit of storing the signal in an integrated memory for improved instrumentation.

### SUMMARY OF THE INVENTION

According to a first aspect of the invention, there is provided a sensor comprising a memory device having a first electrode and a first chemical-sensing layer coupled to the first electrode, arranged such that in use ions proximate the chemical-sensing layer provide an electrostatic potential to change a property of the memory device. The ions may be a target analyte and the chemical-sensing layer may be arranged to site-bind the target analyte to its surface.

The sensor may be electrically or electrostatically coupled to the first electrode such that charges proximate the chemical-sensing layer provide an electrostatic potential between the first electrode and the second electrode of the memory device.

The memory device may be a Memristor, Memcapacitor, or Meminductor.

The sensor may further comprise a first circuit to determine the property of the memory device. The first circuit may comprise means to provide a signal to the memory device, which signal does not substantially alter the property of the memory device and means to determine the property of the memory device from a property of the signal. There may also be a second circuit to set the property of the memory device.

The height of the memory device, measured as the distance between the first electrode and the or a second electrode, is less than about 100 nanometres, preferably less than about 50 nanometres.

The chemical-sensing layer may be arranged to detect one or more of the following ions: H+, K+, Na+ or a neurotransmitter.

There may be an array of sensors integrated on a substrate.

According to a second aspect of the invention, there is provided a method of detecting an analyte and comprising the steps of providing a sensor, providing a sample to be detected proximate to the chemical sensing layer, observing the state of the memory element, and determining a property of the sample by comparing the observed state of the memory element with a previous state.

The property of the sample may be the presence or absence of an analyte and/or the quantity of analyte.

The state observed may be a resistance of a Memristor, capacitance of a Memcapacitor, or inductance of a Meminductor.

The step of detecting the property of the memory device may comprise providing a interrogation signal across the first and second electrodes, preferably a high-frequency interrogation signal.

The method may further comprise the step of applying a voltage difference across the first and second electrodes of the memory device to set the state of the memory device.

The analyte may be neurotransmitters released from one or more neurons proximate the chemical sensing layer.

The analyte may be ions released or consumed as a result of insertion of one or more nucleotides at the end of a nucleotide chain.

According to a third aspect of the invention there is provided a method of manufacturing a chemical sensor and comprising depositing a second electrode on a surface, depositing an active layer or layers ontosaid second electrode, depositing a first electrode onto said active layer(s) and coupling a chemically sensitive layer to said first electrode.

This device can serve as an extremely small chemical sensor (as it relies on nanoscale architectures)

### BRIEF DESCRIPTION OF THE DRAWINGS

Specific embodiments of the invention will now be described by way of example only with reference to the accompanying figures, in which:

FIG. 1 is an illustration of an embodiment showing a side view of an embodiment of the invention;

FIG. 2 is an illustration of an embodiment showing a plan view of an array of Chemical sensors

FIG. 3 is an illustration of an embodiment showing a) a plan view of an array of Chemristors and b) a side view of an exemplary Chemristor;

FIG. 4 is an illustration of a manufacturing process according to an embodiment;

FIG. 5 is an illustration of a Chemristor interfacing a neural synapse;

FIG. 6 shows a) an illustration of a synaptic action, the Hodgkin-Huxley circuit model using b) time-varying conductances and b) Memristors;

FIG. 7 shows a set of graphs showing Memristor resistance changing over time under different conditions.

### DETAILED DESCRIPTION

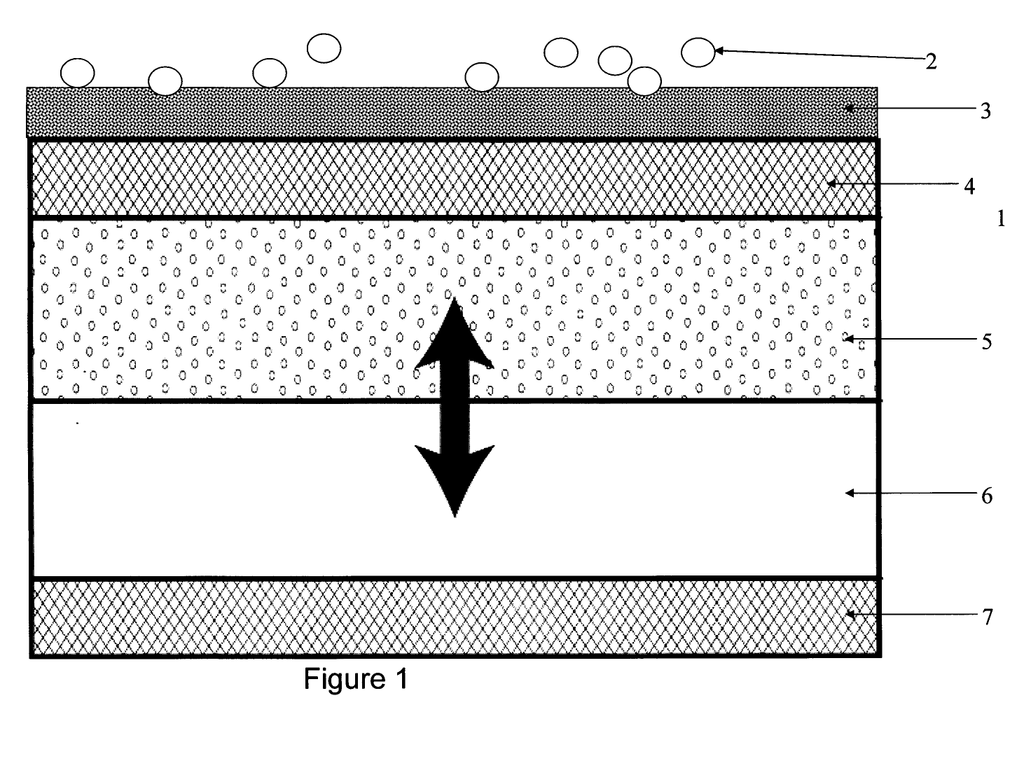

An embodiment of a chemical sensor is illustrated in FIG. 1, showing a chemical-sensing layer coupled to a memory device. The chemical-sensing layer can be functionalised to sense the presence of H+, K+, Na+, particular neurotransmitters or nucleic acids in a sample.

In use, the sample is brought into contact with the sensing layer using microfluidic channels. If the analyte is a suitable match to the functionalised surface, it will bind to the site in a state of association/dissociation. Analystes have a net electrical charge will accumulate on the sensing surface. The charge will create an electric field across the active layer of the memory device thus affecting the memory state of the memory element, which is then read by an external circuit. Signal processing allows the device to determine a property of the sample.

The memory device may be a memristive device, which is a fundamental passive circuit element whose property depends on the history of the electrical biasing applied to it. Some embodiments described below may be termed Chemristors (for combining chemical sensing with a memory element, particularly a Memristor). Such Chemristors are chemical sensing nano-devices. The Memristor provides the added capability of interfacing chemical inputs to a circuit with an inherent neuromorphic response. In other words, the device behaves like a neuron. This device has a reciprocal nature since it can also be used to stimulate post-chemristor neurons. Devices such as Memcapacitors and Meminductors can also be used in place of the Memristor to create “Chemcapacitors” and “Cheminductors”, where the attribute to be detected by the external circuit is the capacitance or inductance, respectively. In some devices the active layer will exhibit a mixture of memresistance, memcapacitance, and meminductance properties.

In one embodiment, a Chemristor is a nano-scale Memristor having a chemically sensitive layer in contact with its top electrode. In the case of the Chemristor 1 depicted in FIG. 1, the charges 2 will cause dopants in the layers 5, 6 to move (according to the polarity of the ion and the dopant) through the Memristor and alter the resistance of the Memristor. The state or change of state of the memory element can be determined by an external circuit connected to the memory terminals, thus determining a property of the sample in question. A chemical event such as a chemical reaction may be detected by determining changes in the property of the sample over a period of time.

Furthermore the nature or identity of the event may be determined by correlating such detected chemical events with known stimuli. For example, a known reagent is added to an unknown sample at a known time resulting in the release of certain ions, which ions are selectively detected by the sensing layer, resulting in a drop in resistance of the Memristor. A signal processing circuit detects the change and determines that an event has occurred, which correlates to the addition of known reagents. From knowledge of possible chemical reactions between the reagent and expected substances in the sample one can identify the substance or portion thereof in the sample. Preferably the known reagents are known to produce the target ions only in the presence of a particular substance.

For example it is known that reagent ‘Y’ that only reacts with molecule ‘X’ to produce ‘Z’ ions. Reagent ‘Y’ is combined with an unknown molecule in a chamber exposed to a Chemristor whose surface is functionalised to detect ‘Z’ ions. If there is no change in resistance indicative of such ions, then one can conclude that molecule ‘X’ was not present. If there is a change in resistance indicative of such ions, then one can conclude that molecule ‘X’ was present.

In a specific example (discussed further below) Y may be dATP (Deoxyadenosine triphosphate), X may be a nucleic acid having an unmatched base at a point immediately subsequent a sequence on the nucleic acid hybridised to a complementary primer. Z may be hydrogen ions released as a dATP nucleotide binds to the 3′ end of the primer. The dATP will only become incorporated if the unmatched base of the unknown nucleic acid is thymine. Thus detecting hydrogen ions with the Chemristor will indicate that the unknown nucleic acid did have thymine at the point of interest.

In practice, the chemical reaction may not occur for 100% of the molecules, there may be some non-specific binding, there may be ion diffusion, and there may be a weak background ion concentration or small resistance change. In such cases an understanding of these factors will help to correlate a significant resistance change and the presence/concentration of the unknown molecule.

### Structure

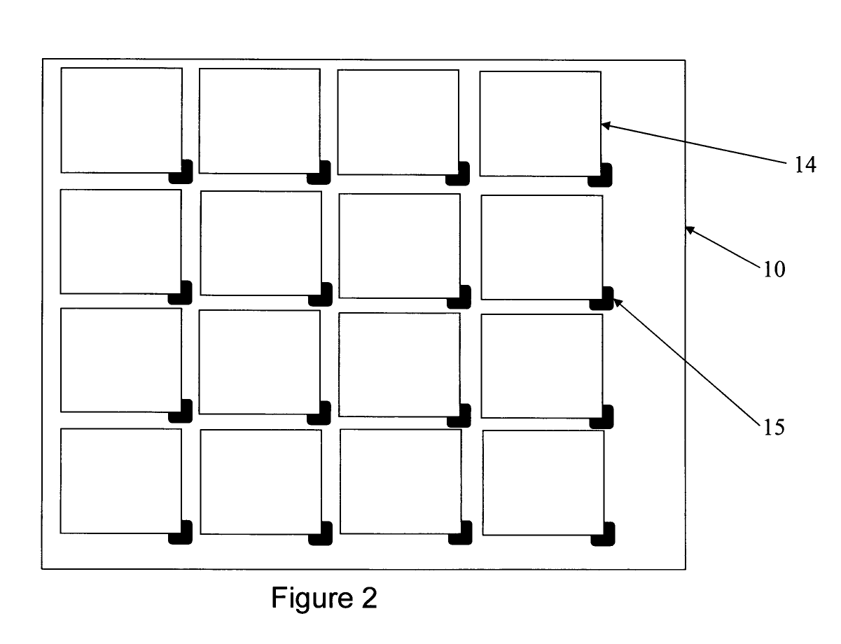

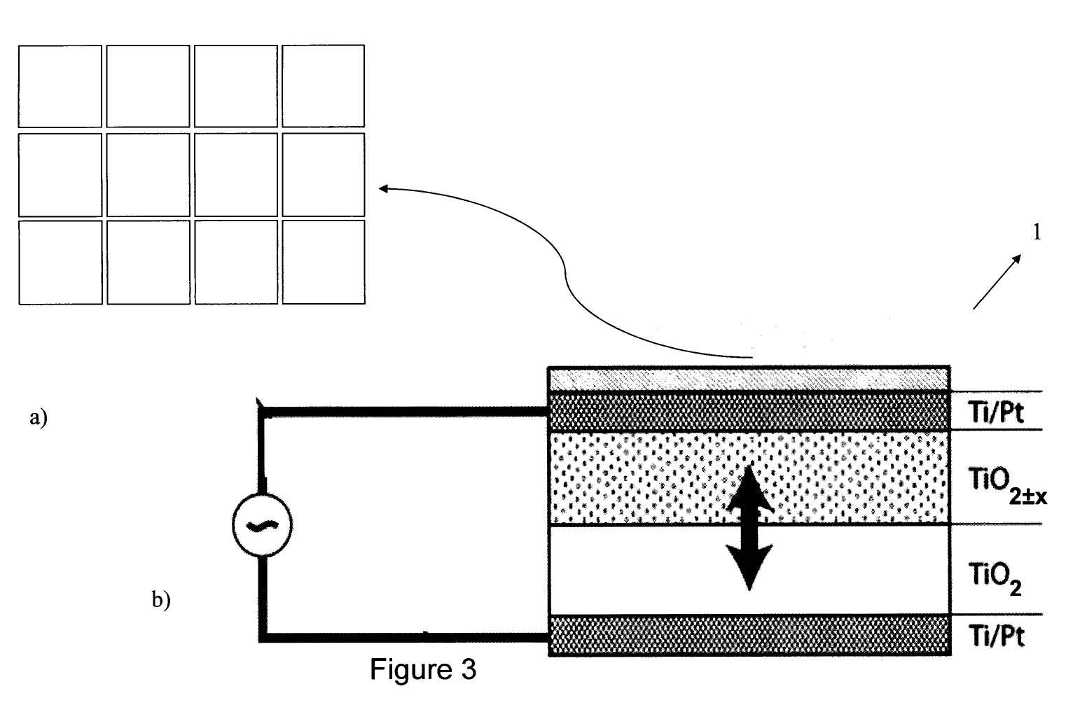

One or more Chemristors may be part of a substrate or lab-on-chip designed for the purpose of detecting particular analytes within a microfluidic sample. In FIGS. 2 and 3, arrays of Chemristors are shown. The arrays may be integrated with or fixed to a substrate. A second substrate having microfluidic channels therein may be coupled to the sensor substrate to direct the fluid containing the sample(s) to the appropriate sensor surface for detection. Signal detection and processing hardware may be integrated with the sensor substrate.

In FIG. 2, an array of sensing surfaces 14 are connected to an array of Memristors 15, each sensing surface being larger than the Memristors. The large sensing surface area increases sensitivity to ions by allowing the binding of more ions and therefore increasing the rate of resistance change of the relatively smaller Memristor. This would be useful if the concentration of ions is low but a fast response is required.

Conversely, if the sensing surface if made very small, the surface can be made highly selective by accommodating less ions or even a predetermined quantity of ions so that ion counting is possible. If the surface is only large enough to accommodate a few target chemicals and the Memristive effect is sufficiently large for each chemical, then signal processor would be able discriminate the number of molecules. Using an array of such Chemristors one could count the total number of molecules in the sample.

FIG. 3 shows an array of Chemristors, each comprising a chemical sensing layer directly fixed to a Memristor of the same dimensions. This arrangement simplifies manufacturing, allowing both parts to be made together and attached without additional vias.

The Chemristor is highly scalable and can be used with microfluidic volumes from pico litres to micro litres.

In some embodiments, called one-sided detection, only one side of the device has a chemically sensitive layer, said layer being exposed to a sample such that the Memristance changes based on the charge at the chemically sensitive layer.

In another embodiment, called two-sided detection, chemical sensing layers are coupled to each side of the Memristor such that the change in Memristance is the net charge across the active layer due to charges at the two chemical sensing layers.

In one application of a two-sided Chemristor, competitive reactions are occurring in two chambers, each chamber exposed to one chemical sensing layer such that the memristance will increase from a neutral state if the ions released from a first reaction are more than the second, or decrease if the ions released from a second reaction are more than the first. For example, the release of hydrogen ions due to nucleotide insertion in one chamber will increase the memristance indicating a property of the analyte, whereas the release of hydrogen ions due to nucleotide insertion in the other chamber will decrease the memristance indicating a different property of the analyte.

In another application of a two-sided Chemristor, concurring reactions are occurring in two chambers, each chamber exposed to one chemical sensing layer such that a first reaction releases cations (or consumes anions) and the second reaction releases anions (or consumes cations) such that the change in Memristance is the sum of the two reactions. The reactions can be seen as reinforcing each other in determining a property of an analyte.

The skilled person will appreciate that any affect on ion concentration in each chamber and any combination from the two chambers will contribute to a net affect on the memristance that can be used to make a conclusion about an analyte.

### Signal Processing

The state or the state change of the device can be read by applying an alternating, preferably high frequency, voltage across the Memristor's electrodes. This ‘probing’ signal has no DC component to leave any significant net effect on the Memristor and thus the current can be measured without significantly altering the state of the Memristor. The skilled person will appreciate that a high frequency probing signal is one where the frequency of the probe is higher than the expected frequency of the ionic signal to be detected. In some applications such as nucleotide incorporation, each incorporation may take only 2 ms (i.e. 500 Hz) but the complete reaction may take 2 seconds (i.e. 0.5 Hz). Thus the probing frequency will be chosen depending on what event is being monitored (individual nucleotides or the overall reaction). Preferably the probe signal frequency is at least 2 times the expected frequency of the ionic signal, more preferably at least 10 times, at least 100 times, or at least 1000 times. Alternative embodiments may set the probing signal frequency to more than 10 Hz, more than 50 Hz, more than 100 Hz, more than 500 Hz, or more than 1000 Hz

Conversely, the device can be programmed or even re-initialised by providing an appropriate biasing voltage at the device's electrodes. Thus the state of any individual Chemristor can be programmed to appropriate conductance values prior to any fluid interaction, allowing a greater degree of flexibility through the set-up of programmable threshold states. Whilst many solid state sensors suffer from drift, mismatch or some form of floating signal before a measurement is taken, a Chemristor may be initialised to a known state just before a sample is introduced or a reaction occurs.

Because the resistance of the Memristor changes with current flow integrated over time, the state of the Memristor at a given time is a measure of the total current that has passed through it since it was initialised. Similarly the Chemristor measures the total charge of the sample integrated over time rather than the present charge of the sample. Thus the Chemristor can detect the total charge observed during a chemical event rather than the instantaneous charge present, which can simplify signal processing as there is no need to detect the maximum signal or perform integration calculations. Moreover, as the memory element will store the result of the chemical event, there is no need to continually monitor the device; the device can simply be read once, after the reaction is complete, thus reducing processing and power requirements.

In one embodiment, a setting circuit applies a −5V DC signal to the electrodes for 5 seconds. This initialises the Memristor to have a high starting resistance, for example 16 kohms. At a later time, a detecting circuit applies a 5 kHz, 1 mv peak-peak signal having zero DC offset across the electrodes for 1 ms. The resulting current that flows from the detecting circuit is measured using an ammeter. The present resistance is determined by Ohms law R=V/I.

### Chemristor Behaviour

In 1971, Leon Chua postulated the existence of the 4th missing fundamental circuit element, which comes in the form of a passive two-terminal device called the Memristor, short for memory-resistor. This device was shown to provide a functional relationship between the time integrals of voltage and current. After the initial proposal of the Memristor, Chua and Kang generalised the concept to memristive systems defined by:

v=R(x)i (3)

dx/dt=f(x,i) (4)

where v is the voltage, i is the current and R(x) is the instantaneous resistance that is dependent on an internal state variable of the device, denoted as x.

A useful property of the Memristor lies in its ability to remember its history, i.e. the previous internal state variable of the device. In Chua's seminal paper, it was shown that a minimum of 15 transistors are required to reproduce the behaviour of one Memristor.

Memristive behaviour has in fact existed for many years but the phenomenon was not properly deciphered until a team from Hewlett-Packard Laboratories (HP) successfully correlated the characteristics of nanoscale switches in crossbar architectures with the theory presented by Chua in 2008. The HP device consists of an active region made up of a thin-film of titanium dioxide (TiO₂) sandwiched between two platinum electrodes. This film essentially comprises a bi-layer with the first region being composed of a TiO₂₋ₓ thin film, which is oxygen deficient, while the other region is made up of stoichiometric TiO₂ that is electrically insulating, thereby creating an internal conductivity gradient (TiO₂/TiO₂₋ₓ). Since 2008 a number of memristive devices have been reported based on titanium oxide films with oxygen excess (TiO₂/TiO₂₊ₓ), Ag loaded Si films and TiO₂ sol-gel solutions.

In the presence of a voltage potential across the electrodes, dopants move in the active layer to change the relative proportion of the insulating layer and conducting layer. The Roff value is the resistance of the device when the insulating portion is maximised; the Ron value is the resistance of the device when the insulating portion is minimised.

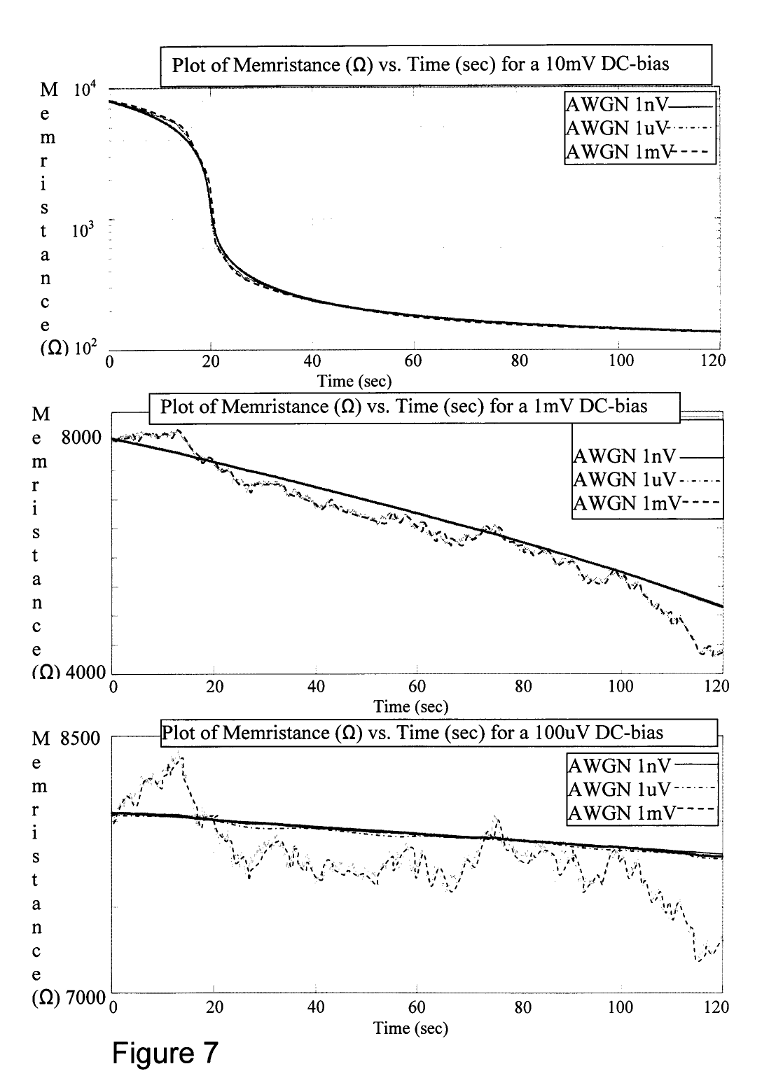

The implementation of appropriate chemical sensing membranes (SiO₂, Si₃N₄, Al₂O₃, Ta₂O₅ as well as various types of enzymes) allows the binding of distinct ions (H⁺, K⁺, Na⁺ and/or various types of neurotransmitters) that collectively modulate the memristance of the device through electrostatic potentials. The mechanism of operation is demonstrated in FIG. 7 as a DC biasing on a Memristor with Width=5 nm, Depth=10 nm, Ron=100Ω, Roff=16 kΩ and μ=10⁻¹⁴ m²/Vs. The simulation shows the resulting changing memristance of a Memristor biased with electrostatic potentials of 10 mV, 1 mV and 100 μV with additive white gaussian noise (AWGN) floors of 1 nV, 1 μV and 1 mV.

It is noted that the memristance modulation follows the amplitude of the applied bias, which represents the ionic strength of the solution under test. In addition, this effect becomes significantly apparent over a longer timeframe. This has various ramifications, since in principle a Chemristor is capable of exhibiting an extremely high chemical sensitivity (down to a single ion), provided that the measurement timeframe is long enough. This statement is also supported by the fact that the ionic electrostatic potentials (V_{E}) are inversely proportional to the distance r that separates the chemical sensing area (where the ions are located) and the grounded bottom electrode of the device.

$${V}_{E} = \frac{q}{4 {πɛ}_{0} r} \qquad ( 5 )$$

where q denotes the ionic charge and ε₀ is the permittivity of free space. In a Chemristor the distance r is infinitesemal, typically 10 nm≦r≦50 nm, thus the resulting electrostatic potential is relatively large.

Another interesting property of the Chemristor is noise immunity. The modulation of the device's conductance depends on the charge that has passed through the device, which is effectively the integral of the applied signal over the measurement timeframe. Over a long timeframe, the integral of the noise is minimal, essentially resulting into a minimal pertubation of the device's state, while the sole contribution to the device's memristance arises from the overall electrostatic potential due to the ionic strength of the solution and the period over which it is exposed to the sensing layer.

### Exemplary Applications

Applications of the Chemristor in the field of molecular biology may include sequencing by synthesis and determination of Single Nucleotide Polymorphisms, or nucleic acid sequences of interest.

In one embodiment:
A sample to be tested is provided and purified and placed in a microfluidic chamber bringing it in contact with the Chemristor.
The treated sample is amplified using PCR.
The copies are denatured and a probe is hybridised up to the area of interest.
Sequencing-by-synthesis is performed, adding different dNTP to the chamber one at a time. Hydrogen ions are released during the incorporation of a complementary dNTP at the location to be determined. After each known dNTP addition, the resistance of the Chemristor is measured.

In an alternative embodiment:
A sample to be tested is provided and purified and placed in a microfluidic chamber bringing it in contact with the Chemristor.
The treated sample is amplified using PCR.
A probe, having a nucleotide sequence complementary to a nucleotide sequence of interest on the sample, is hybridised to denatured single stranded-copies of the amplified DNA
Multiple dNTPs are added to the chamber together or one at a time. Hydrogen ions are released during the incorporation of multiple dNTPs at the 3′ end of the probe, or chain extension. In the presence of a target sequence complementary to the probe, chain extension and hydrogen ion release will occur, resulting in discrete fluctuations in the electrical output signal of the Chemristor. This may be compared with the absence of a target sequence complimentary to the probe. After each known dNTP addition, the resistance of the Chemristor is measured.

In yet another embodiment:
A sample to be tested is provided and purified and placed in a microfluidic chamber bringing it in contact with the Chemristor and with apparatus for thermocycling of the sample.
A set of amplification primers, are added to the chamber, along with amplification reagents, a polymerase enzyme and an excess of dNTPs
The sample is thermocycled to perform PCR, and the resistance of the Chemristor is monitored as the thermocycling proceeds. Hydrogen ions are released during the incorporation of multiple dNTPs at the 3′ end of the probe during the chain extension phase of PCR. In the presence of a target sequence complementary to the primers, chain extension and hydrogen ion release will occur, resulting in discrete fluctuations in the electrical output signal of the Chemristor. This may be compared with the absence of a target sequence complimentary to the primers. However, since the amplification mixture will buffer the release of hydrogen ions, amplification must proceed beyond a threshold number of cycles for buffering capacity of the sample to be overcome in order to generate an electrical output signal in response to a change in pH arising from chain extension during amplification in the presence of target DNA

Alternatively there may be multiple chambers, each containing a Chemristor with a different dNTP or a different probe. Any of the above embodiments may combine steps or introduce reagents in a different order.

The change in resistance from start to end of the reaction for each sensor can be compared to the change of another sensor to determine whether a significant change has occurred and thus which corresponding chambers have experienced a chemical reaction. A significant change may be determined with reference to a threshold difference in resistance change. Nucleic acid base(s) can be identified from knowledge of which chambers experience a chemical reaction and the identity of reagents contained therein.

Furthermore, the memory effect of the Chemristor may be used to increase “signal-to-noise” to a greater extent than use of standard chemical sensors, by providing a comparison of present signal with previous signal values. Algorithms to boost signal-to-noise may be implemented in hardware or software.

Advantageously the Chemristor value represents the integral of the ionic fluctuations during the reaction and holds this value in the internal memory, even after the ionic species have diffused away. Thus there is less need to sample the sensor(s) at a fast rate to observe the reaction with the attendant high data throughput. Nor is there need for complex signal processing to detect peaks or compute integrals of the ionic concentration.

The above methods may be used with or without thermocycling. For example, thermocycling may be used to facilitate optimisation, using taq polymerase as a sequencing enzyme. The pH of the reagent mixture may be adjusted for example. A increase of the pH will lead to the production of more hydrogen ions, but will also tend to kill off the reaction. Trials have shown pH 8 to be a useful value of pH. Magnesium may be added to the reagent mixture to actuate the enzyme. The concentrations of the reagents may be modified.

A typical thermocycling sequence is set out in table 1.

TABLE 1
Cycle Sequencing

| Temperature | Duration | Function |
|---|---|---|
| 95° C. | 30 sec | Denaturing of DNA template |
| 55° C. | 30 sec | Annealing of primer |
| 72° C. | 60 sec | DNA extension and termination |

For a sufficiently small Chemristor and chamber, single molecule detection is possible. For example, a DNA strand has a diameter of 2 nm and length of 0.34 nm per base (e.g. 34 nm long for a 100 base strand). Thus a chamber of 50 nm per side fitted to a similar sized Chemristor could be arranged to receive a fluid sample containing DNA or DNA fragments. Without amplifying the DNA, the DNA may be combined with known reagents to identify base(s) of the DNA as described above.

Preferably there is an array of chambers and an array of Chemristors. A DNA sample may be divided into suitable small volumes and dispensed to each chamber. There will be a Poisson distribution of DNA in chambers, preferably whereby some chambers will have no DNA, many chambers will have one strand, and few chambers will have two or more strands.

Sequencing-by-synthesis is performed, adding different dNTP to the chamber one at a time. Hydrogen ions are released during the incorporation of the known dNTP complementary to the base on the strand to be sequenced. After a set period, the resistance of each Chemristor is measured. Preferably there is a wash step between each step of adding a dNTP to remove remaining ions. Preferably the Chemristor resistance is set to a predetermined resistance, for example the high-resistance state, using the setting circuit after or during the wash step.

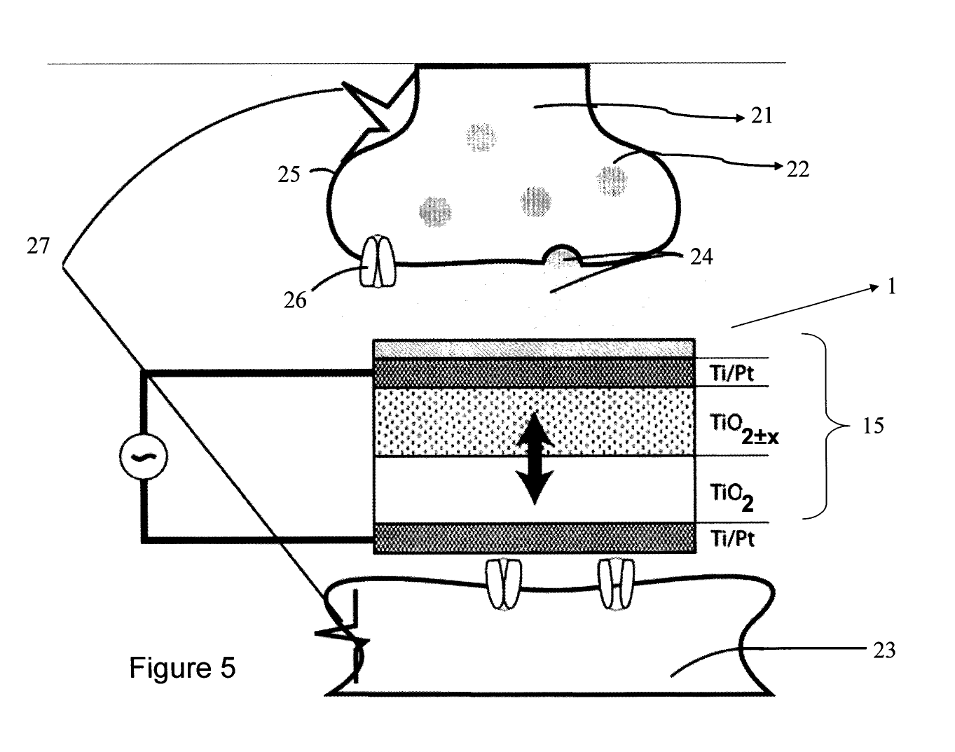

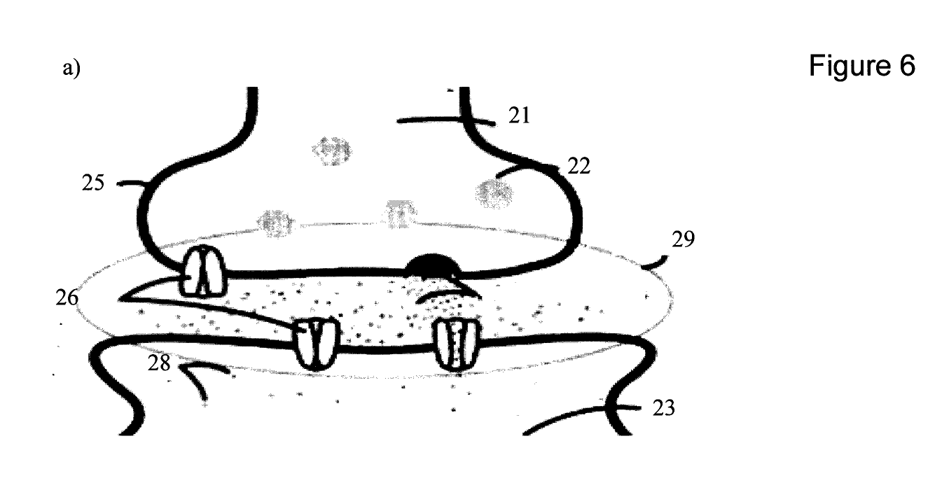

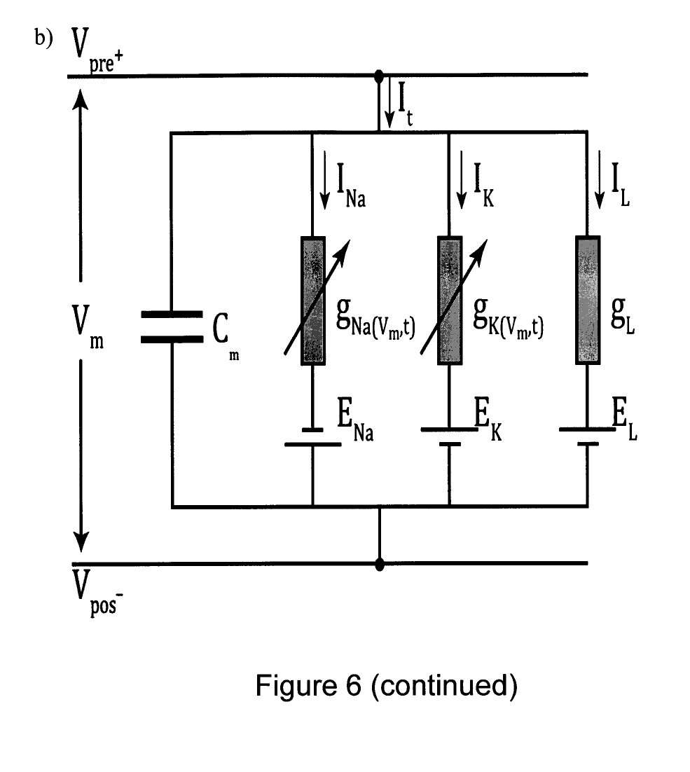

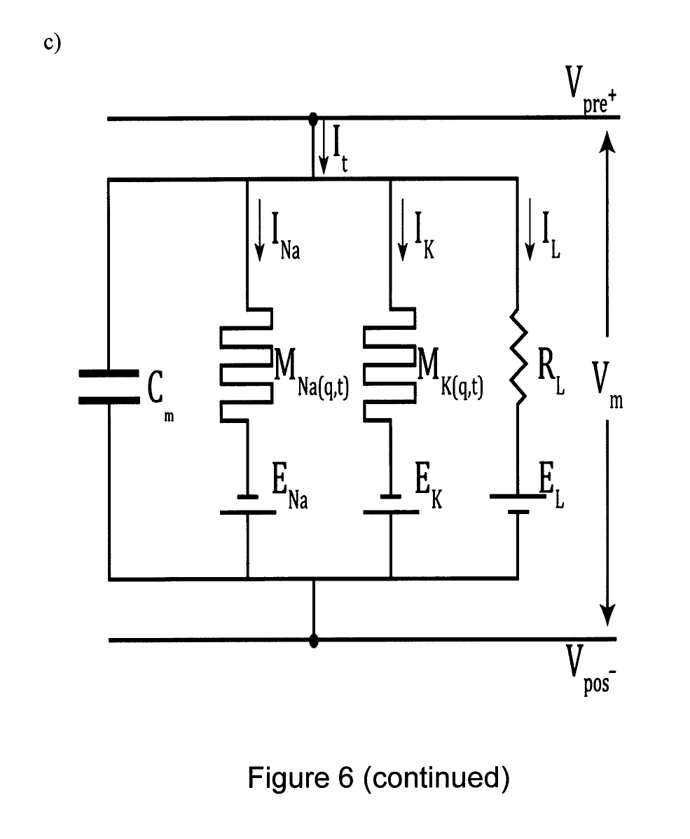

Another application of the Chemristor is the monitoring of neural activity. A synapse of a neuron interfaced by a Chemristor is illustrated in FIG. 5. Normally, action potentials 27 on the pre-synaptic neuron 21 cause the release of neurotransmitters 24 in the synaptic cleft, which alter the strength of the individual ionic channels 26. Depending on the amount of neurotransmitters released the ionic channels open and close allowing the flow of ions into the postsynaptic neuron 23, which cause the propagation of a synaptic potential.

In a similar fashion, the memristance of either a Memristor or Chemristor is dictated by the amount of charge that has flown through it.

$$M ( q ) = \frac{d {φ}_{q} / d t}{d q / d t} = \frac{V ( t )}{I ( t )} = M ( q ( τ ) ) \qquad ( 6 )$$

Analogous to the Hodgkin-Huxley model, individual Na⁺ and K⁺ Chemristors can be used, to replicate the strength of different ionic channels, which is a more elegant alternative to CMOS log-domain circuits both in complexity and space.

Neural monitoring can be deployed by a number of Chemristors that may result in a significantly smaller system where at the same time the synaptic dynamics can be emulated more accurately than other chemical sensors.

In FIG. 5, a Chemristor 1 is placed at the synaptic junction of a neuron. During the firing of a synapse, vesicles 22 carrying neurotransmitters are moved towards the synaptic cleft and release neurotransmitters 24 through the pre-synaptic axon membrane 25 which are detected by the sensing layer. An external probing circuit can detect the changed in the resistance to understand the signalling of the adjacent neuron(s).

Signal processing may reveal the firing patterns of individual neurons within a group. For example, after a period of neural activity, those neurons next to Chemristors with the greatest change in memristance are determined to be the strongest/most active.

An advantageous property of Chemristors is the ability to record the time-integrated strength of neurotransmitters. Therefore an array of Chemristors may reveal which neurons are firing most often, not just the instantaneous firing. This has analogues to the learning property of neurons.

### Manufacture

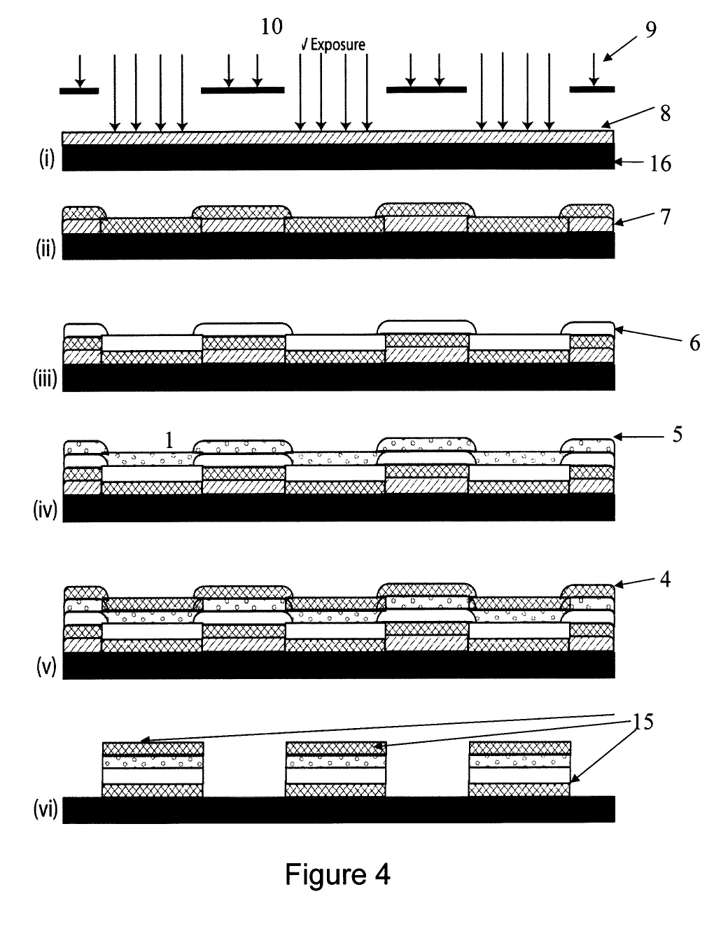

A Memristor may be made as is illustrated in FIG. 4, and described as follows:
I. A photo-resist layer 8 is laid down on a substrate 16 and is exposed through a mask 9 to UV light 10. Development of the resist removes certain portions of the photo-resist;
II. A bottom electrode 7 is deposited;
III. A first material is deposited in an environment containing an inert gas (such as Argon) to create the first active region 6;
IV. The same or different material is deposited in an environment where a reactive gas is present (such as Oxygen) to create the second active region 5;
V. A top electrode 4 is deposited.
VI. Lift-off removes material above the extant photo-resist to reveal the final Memristor devices 15.

The deposition of all layers can be performed at room temperature, with no need for a temperature-annealing step as described in previous techniques. Each sub-layer can be of any thickness from a few nanometres (nm) to a micrometer.

A variation of the process described above is shown in FIG. 3, where a masking layer 16 is laid down as a final layer, subsequently patterned using for example photolithography, and an etchant used to remove the undesired portions.

The process may take place in a high-vacuum chamber. For example, the chamber may initially be at 10⁻⁷ mbar for the deposition of the electrode. During the deposition of the active regions 5 and 6, the pressure may increase to 2×10⁻² mbar as the inert and/or reactive gas is introduced. In one exemplary embodiment, the Argon flow is 12 SCCM (standard cubic centimeters per minute) for step iii above, becoming 12 SCCM of O₂ during step iv above.

The Memristor may also be manufactured according anyone of the methods disclosed in the references 6-9, 15, or 16 listed above.

A Chemristor may be made by depositing a material between steps V and VI to create a chemical sensing layer 3. For example the material may be Silicon Nitride to detect Hydrogen ions, or distinct receptors can be integrated directly on one of the electrodes of the Memristor to detect bacteria, virus particles, DNA, drugs, antibodies and electrolytes. A table of possible enzymes and corresponding targets are provided in Table 1.

TABLE 1
Small-molecule transmitter
substances and their key biosynthetic enzymes.

| Transmitter | Enzymes |
|---|---|
| Acetylcholine | Chlorine acetyltransferase |
| Dopamine | Tyrosine hydroxylase |
| Norepinephrine | Tyrosine hydroxylase & dopamine β-hydroxylase |
| Epinephrine | Tyrosine hydroxylase & dopamine β-hydroxylase |
| Serotonin | Tryptophan hydroxylase |
| Histamine | Histidine decarboxylase |
| γ-Aminobutyric acid | Glutamic acid decarboxylase |
| Glycine | Enzymes operating in general metabolism |
| Glutamate | Enzymes operating in general metabolism |
| Noradrenaline | |
| Somatostatin | |

Alternatively the chemical sensing layer 14 may be fabricated separate from the Memristor element and then connected with conducting vias to the Memristor electrode. Advantageously, the chemical sensing layer may be made to a different size than the Memristor element so as to optimise the sensitivity and/or the selectivity of the sensor.

The Memristor is highly scalable such that elements may be made having lengths and/or width anywhere from 10 um to 1 nm. As noted in [7] the Memristance effect varies inversely with the thickness of the active layer of the device, such that a larger memristance spectrum is observed. Additionally, as denoted by equation (5) as the thickness of the Chemristor's bi-layer decreases the sensor is anticipated to become more sensitive. The binding of ions on the sensing membrane of the Chemristor acts as a DC bias that causes a gating similar to that exhibited in ion-channels, with the difference that here we do not allow the gating of ions present in the solution; instead existing mobile dopants in the device core are displaced. Since, the charge q is related to the ionic strength of the solution under test, the conductance modulation of the device over a given timeframe is analogous to the ion concentration in the solution, as illustrated in FIG. 2a. In addition, the infinitesimal distance r (10 nm≦r≦50 nm) augments the effective electrostatic potential, which results into a higher memristance change and consequently a faster chemical detection.

In one embodiment, an array of 529 sensing surfaces of dimensions 10 um×10 um are connected to Memristors of dimensions 1 um×1 um. In another embodiment the dimensions of the sensing surfaces and Memristor are about 1 um, 100 nm, or 10 nm.

Chemristor devices offer many advantages over other chemical sensors. As can be seen from Table 2, which illustrates some advantages of a Chemristor compared to a Nanopore, the advantages may be both technical and commercial.

TABLE 2

| Attributes | Nanopores | Chemristor | Application Remarks |
|---|---|---|---|
| Lifetime | hours | weeks | Sensor robustness |
| Manufacturability | demanding | easy | Cost and reliability |
| Reproducibility | moderate | high | Standardisation and |
| | | | reliability |
| Handling | demanding | relaxed | Ease of use |
| Integration Footprint | μm-scale | nm-scale | Spatial resolution |
| Integration with | low | high | Cost and functionality |
| conventional circuitry | | | |
| Programmability | low | high | Intrinsic data processing |

Although the invention has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in the invention, whether alone or in any appropriate combination with any other feature disclosed or illustrated herein.

1. A sensor comprising:
a memory device having a first electrode and a second electrode; and
a first chemical-sensing layer coupled to the first electrode, arranged such that in use ions proximate the chemical-sensing layer provide an electrostatic potential to change a property of the memory device.

2. A sensor according to claim 1, wherein the first chemical-sensing layer is electrically connected to the first electrode such that charges proximate the chemical-sensing layer provide an electrostatic potential between the first electrode and the second electrode of the memory device.

3. A sensor according to claim 1, wherein the first chemical-sensing layer is electrostatically coupled to the first electrode such that charges proximate the chemical-sensing layer provide an electrostatic potential between the first electrode and the second electrode of the memory device.

4. A sensor according to claim 1, wherein the memory device is one of a Memristor, Memcapacitor, or Meminductor.

5. A sensor according to claim 1, further comprising a first circuit to determine the property of the memory device.

6. A sensor according to claim 5, wherein the first circuit comprises means to provide a signal to the memory device, which signal does not substantially after the property of the memory device and means to determine the property of the memory device from a property of the signal.

7. A sensor according to claim 1, further comprising a second circuit to set the property of the memory device

8. A sensor according to claim 1, wherein the height of the memory device, measured as the distance between the first electrode and the or a second electrode, is less than about 100 nanometres, preferably less than about 50 nanometres.

9. A sensor according to claim 1, wherein the chemical-sensing layer is arranged to detect one or more of the following ions: H+, K+, Na+ or a neurotransmitter.

10. An array of sensors according to claim 1, the array of sensors being integrated on a substrate.

11. A method of detecting an analyte and comprising:
(a) providing a sensor as described in claim 1;
(b) providing a sample to be detected proximate the chemical sensing layer;
(c) observing the state of the memory element; and
(d) determining a property of the sample by comparing the observed state of the memory device with a previous state.

12. A method according to claim 11, wherein the property of the sample is the presence or absence of an analyte.

13. A method according to claim 11, wherein the property of the sample is a quantity of analyte.

14. A method according to claim 11, wherein the state observed is a resistance of a Memristor, capacitance of a Memcapacitor, or inductance of a Meminductor.

15. A method according to claim 11, wherein the step of detecting the property of the memory device comprises providing an interrogation signal across the first and second electrodes, preferably a high-frequency interrogation signal.

16. A method according to claim 11, further comprising applying a voltage difference across the first and second electrodes of the memory device to set the state of the memory device.

17. A method according to claim 11, wherein the analyte is neurotransmitters released from one or more neurons proximate the chemical sensing layer.

18. A method according to claim 11, wherein the analyte is ions released or consumed as a result of insertion of one or more nucleotides at the end of a nucleotide chain.

19. A method of manufacturing a chemical sensor and comprising:
(a) depositing a second electrode on a surface;
(b) depositing an active layer or layers onto said second electrode;
(c) depositing a first electrode onto said active layer(s); and
(d) coupling a chemically sensitive layer to said first electrode.
